(19) United States
(12) Patent Application Publication
(10) Pub. No.: US 2008/0019383 A1
(43) Pub. Date: Jan. 24, 2008

(54) Telecommunications switching

(75) Inventors: Bradley John Wainwright, Kew (GB); Michael Joseph Cooper, Farnham (GB); Mick Mulvey, Ipswich (GB); James Peter Patterson, London (GB); Peter Joseph Brucia, Fairfield, CT (US); Dan Hubscher, South Orange, NJ (US); Carl Everard Hunte, Langhorne, PA (US); Mitchell Garfield McGuire, Bridgewater, NJ (US); Richard Roy Snape, Morristown, NJ (US)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS public limited company, London (GB)

(21) Appl. No.: 11/594,972

(22) Filed: Nov. 9, 2006

Related U.S. Application Data
(63) Continuation-in-part of application No. 11/489,719, filed on Jul. 20, 2006.

(51) Int. Cl. H04L 12/56

(52) U.S. Cl. 370/401

(57) ABSTRACT

A virtual private data network is overlain on an internet connection to allow prioritisation of connection between two or more specified terminations over a switched network, thereby minimising latency in the system. Data to be transmitted between the specified terminations is identified by a weighting prefix and its routing is prioritised over other data for the same destination termination.

This application is one of two filed on the same date, and has applicant's reference B31250. It is a continuation-in-part of application 489719/11, filed on Jul. 20^{th} 2006.

This invention relates to telecommunications systems, and in particular to the provision of dedicated connections between defined points.

It is now possible to connect almost any telecommunications device to any other using conventional switched networks (circuit switched or packet switched). For many time-critical applications, minimising network-induced latency is a priority.

For some applications the problems of latency and of contention with other subscribers for bandwidth, mean that dedicated point-to-point links are still preferred. However, such dedicated point-to-point physical circuits are expensive to provide as they require dedicated infrastructure to be installed over the entire length of the link, and there are few synergies available to reduce the cost of installing several such links. They are also less robust to system failure, and replacement or diversion (whether in an emergency or otherwise) requires major re-installation work.

Dedicated “virtual” point-to-point links can be provided over a switched network. In essence, capacity is prioritised in the switch for each such point-to-point link, which is routed so as to minimise latency. Developments have been made that can minimise latency in the switch itself, by applying capacity-planning rules to avoid bottlenecks at the physical and data-link levels, and by choice of the actual physical switching equipment used. However, in a packet data system there is also the latency in the routing system which controls the switches.

The present invention provides a way of configuring a switch to provide a virtual link operating entirely at the data link level, bypassing the variable latency of the network layer (the router)

According to a first aspect of the present invention, there is provided a communications system having means for operating a virtual private connection over a switched network between at least two specified terminations, the system comprising means for identifying data to be transmitted between the specified terminations, means for generating data header information for such data, and one or more switches arranged to recognise said data header information and transmit data having such information over predetermined connections in the network.

According to another aspect of the present invention, there is provided a method of establishing a communications link between at least two specified terminations over a switched network, to operate as a virtual private connection, wherein data to be transmitted between the specified terminations is identified, data header information is generated for such data, and the switches in the network are controlled to recognise such header information and route data having such header information over predetermined connections in the network.

Each termination point may have a plurality of such virtual private connections, all connected across a single physical connection to the same switch. This allows the switch to associate the physical connection with the termination point, preventing impersonation or the creation of unauthorised private links.

In a preferred embodiment, the switches in the network are controlled by a router, the router initially recognising the data header information and generating instructions to the switches to set up the routings to be used by the switches to transmit data carrying the same data header information

Data carrying said data header information may be prioritised over other data for the same destination terminations, such that data latency is minimised.

The routing of said data may be controlled to be routed over a primary connection and at least one secondary connection, the secondary connection being controlled to deliver the data in the event of failure of the primary connection. This may be achieved by having an intermediate weighting for the secondary connection.

If it is likely that several terminations may all require access to data from one termination at the same time, the same data may be transmitted over a plurality of physical circuits to, or from, one or more of the terminations, the separate circuits carrying the data from, or to, different terminations.

The system may be used for individual users to access data on demand, or may also be used to allow a single information provider to supply data to several subscribers simultaneously. In the latter case, the connections may be arranged to be one-way, in accordance with our co-pending application entitled Telecommunication Multicast System, filed on the same date as the present application, which is a continuation in part of application no 489718/11. This prevents the multicast connection being used to transmit data between the destination terminals in an uncontrolled manner.

A number of embodiments of the invention will now be described, with reference to the drawings, in which

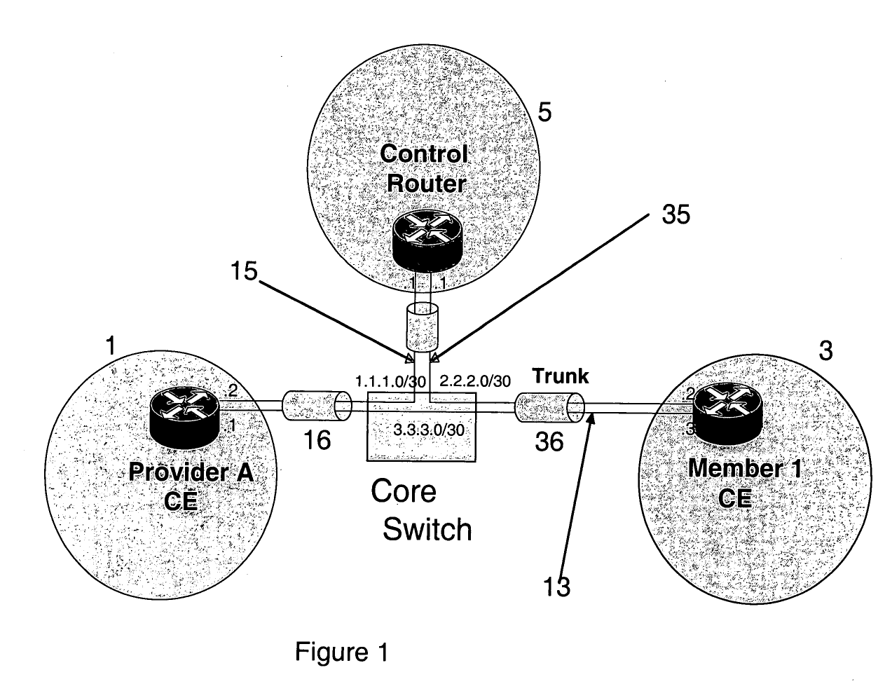

FIG. 1 illustrates the control plane of a simplified embodiment according to the invention, for one-to-one provision:

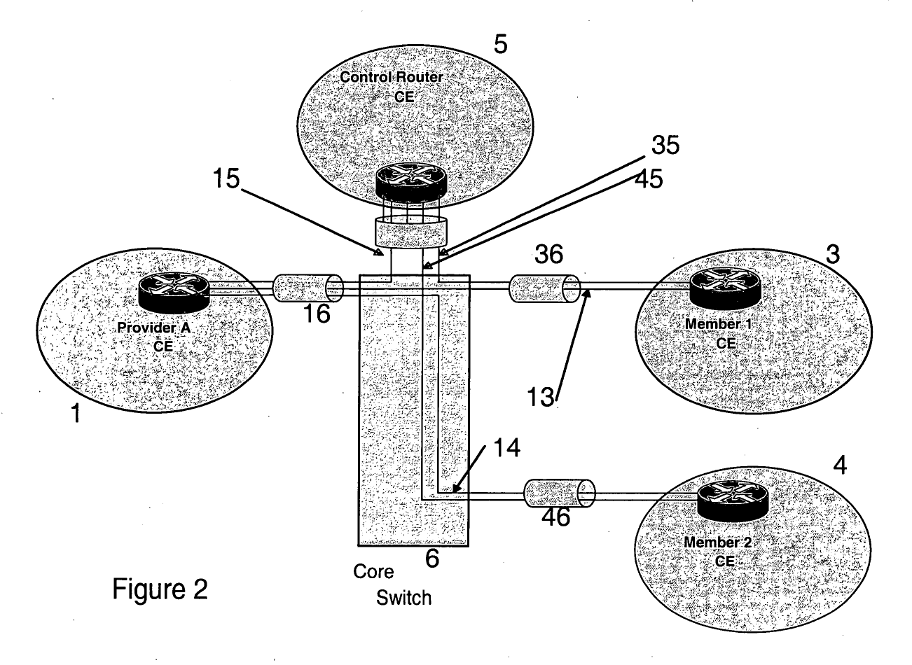

FIG. 2 extends this principle to a one-to-many provision;

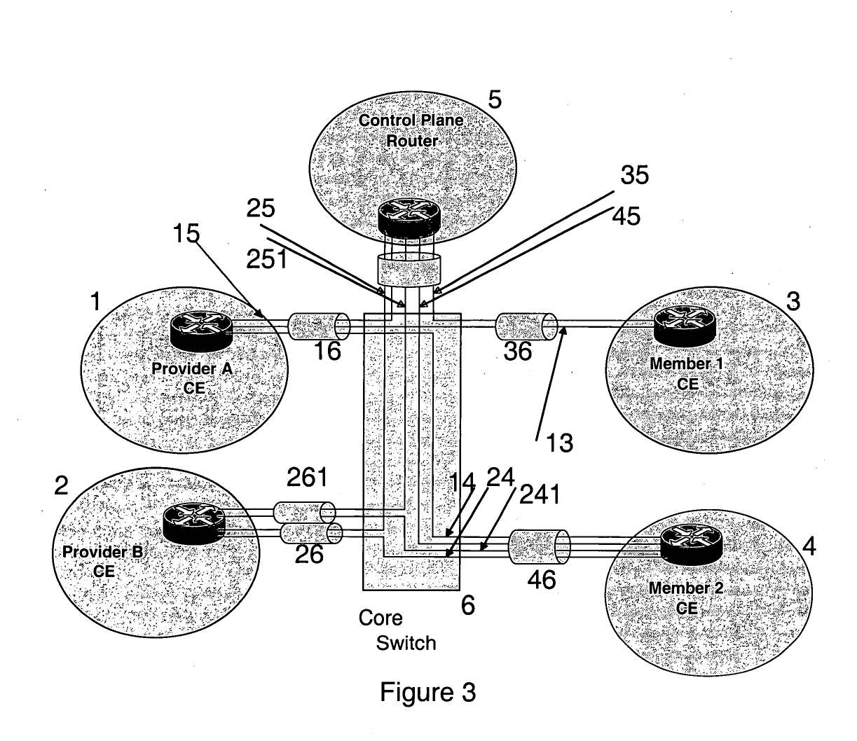

FIG. 3 further extends this principle to a many-to-many provision;

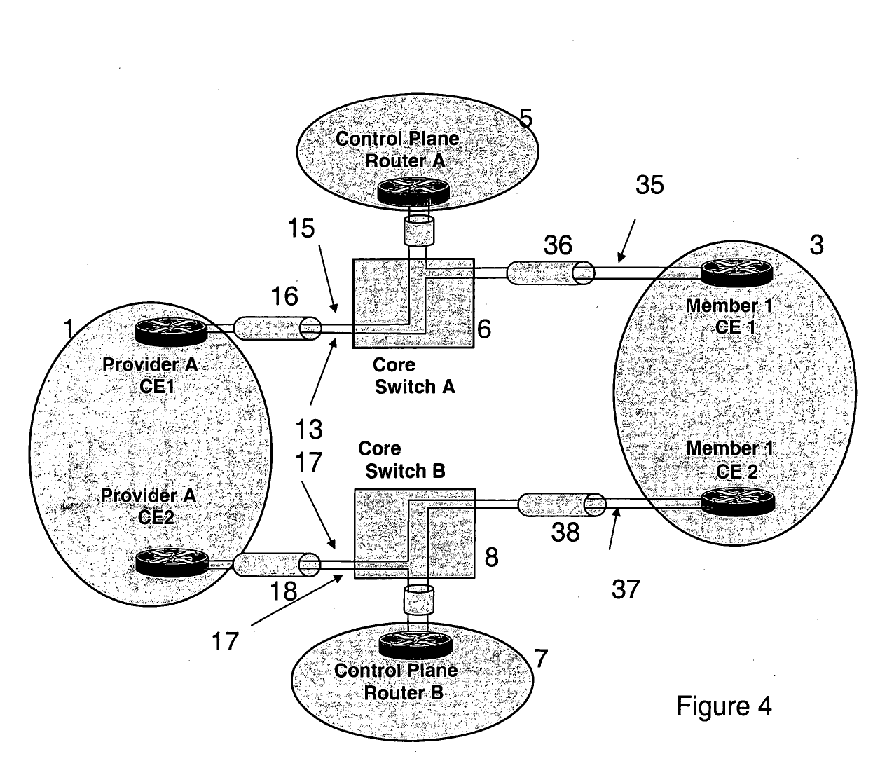

FIG. 4 shows a further embodiment, having resilient provision.

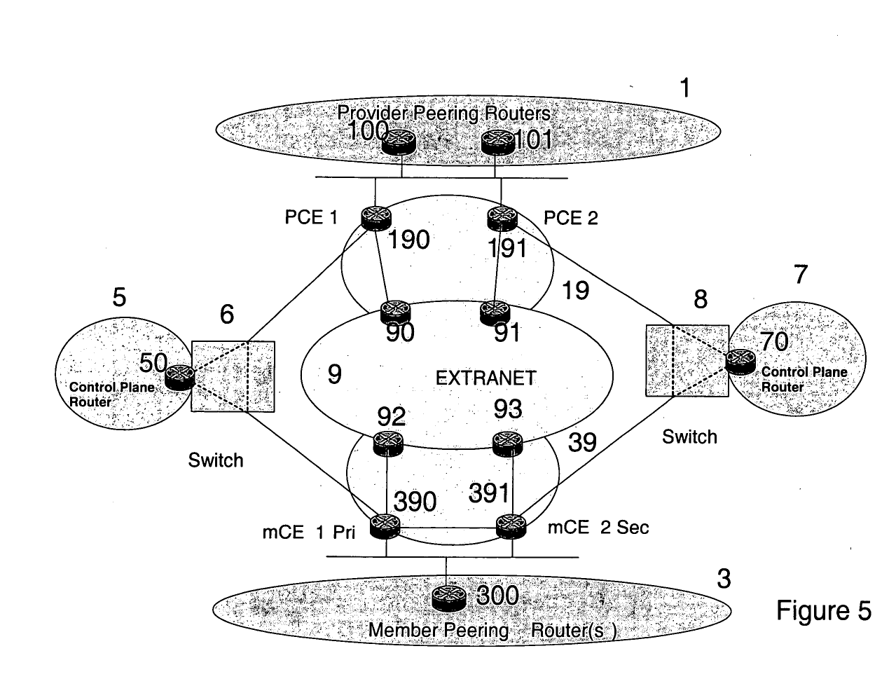

FIG. 5 shows how the functionality of the earlier embodiments may be overlain on a conventional network

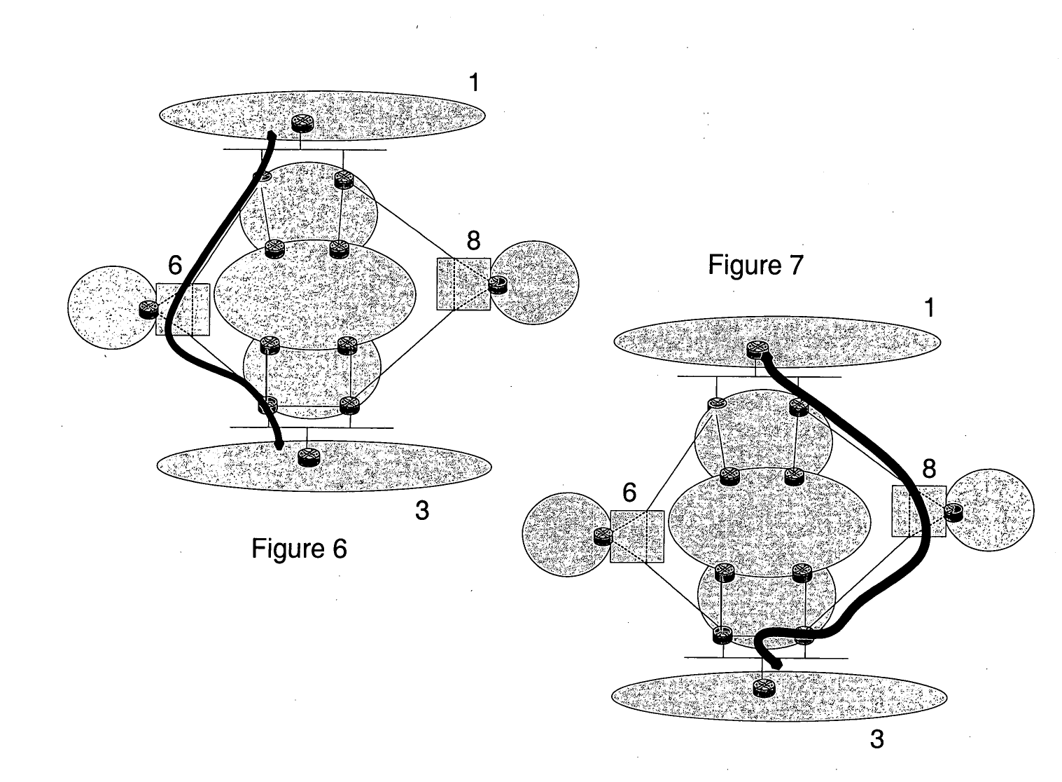

FIG. 6 illustrates the flow of data in the system of FIG. 5 in a normal situation

FIG. 7 illustrates the flow of data in the system of FIG. 5 in an abnormal situation.

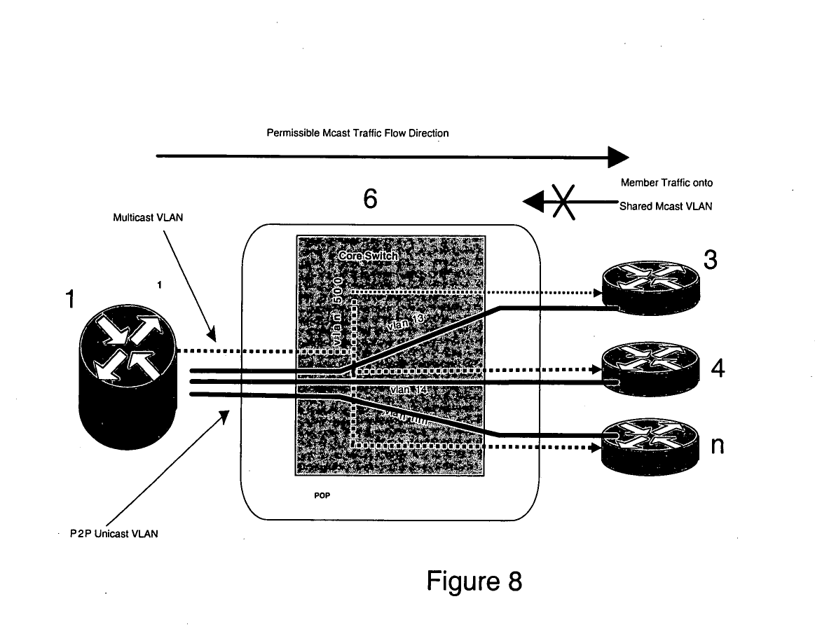

FIG. 8 is a representation of a virtual local area network incorporating the invention

The embodiments provide delivery of data using dedicated point-to-point VLANs, independent from the host system, but in such a way that the users can simultaneously access the host network conventionally for connections without point-to-point connectivity, and maintaining the standard paradigms, so maintaining routing policies into the customer domain. In the event of failure of the dedicated VLAN, the users may recover feed from the conventional connection.

FIG. 1 illustrates the control plane of a simplified embodiment according to the invention. For the purposes of illustration the two terminations 1, 3 are described as “information provider” and “subscriber” respectively—in general the subscriber 3 addresses requests for information to the provider 1, and the requested information is returned to the subscriber 3 in response.

The provider 1 and subscriber 3 are both connected by way of trunk connections 16, 36 to a switch 6, the connections being under the control of a control plane router 5. The trunk is typically a dense wave division multiplex (DWDM) optical link. The Core switch 6 provides the switching capability that delivers both the infrastructure and service connectivity. The control plane router 5 provides a security enforcement layer in terms of routing policy control. The control plane router 5 is connected, in the control plane, to the provider 1 and subscriber 3 over respective point to point VLANs 15, 35 running under eBGP (external border gateway protocol).

Provider Prefixes are advertised to the Subscribing Member 3 via the Control Plane Router 5. On reception at the Control Plane Router 5, the Prefixes are assigned standard BGP Community markings to indicate, amongst other things, the Provider 1 to which they belong. At the Subscriber equipment 3 an in-bound Route-map is used to set the next-hop for this prefix as the IP address of the Provider end of the Traffic Forwarding VLAN. For example, in FIG. 1 the next hop would be set to 3.3.3.1. (Note that the IP addresses used are for ease of presentation and are not representative) The same Prefix advertisement and next-hop association is used for Member-to-Provider Prefix advertisement.

FIG. 2 extends this principle to a Provider 1 delivering to two Members (subscribers) 3, 4. Each Member 3, 4 has a dedicated Point-to-Point VLAN connection 35, 45 to the Control Plane Router 5. An eBGP Peer within this VLAN delivers to each member the Prefixes to which the member subscribes. The Member CE's Inbound BGP Route-map attached to the Control Plane eBGP Peer will set the next-hop appropriate to the Traffic Forwarding VLAN to the Provider 1 based on the standard BGP Community Tags.

In general a single physical Connection 16 from a Provider 1 will comprise a single eBGP Peering VLAN 15 to the Control Plane Router 5, together with a number of Traffic forwarding VLANs 13, 14 equal to the number of Subscribing Member Sites 3, 4. Where bandwidths dictate a Provider may have need for more than one physical connection 16. If this is the case, Member VLANs 3, 4 will be spread across the Physical connections. At the member site, the BGP Community tags will be used to correctly map the Member to the correct traffic Forwarding VLAN for that Provider's Service connection. The association of each member with a physical connection also allows the switch 6 to check that data purporting to originate from a given member actually does so, preventing unauthorised links being set up and impersonation of one member by another.

FIG. 3 shows the scheme extended to multiple Providers 1, 2 as well as multiple Members 3, 4. In the simple case shown, one Member 4 subscribes to Services from both Providers 1,2. Another Member 3 subscribes to Services only from the first Provider 1. Because of bandwidth demands, the second Provider 2 has Members 4 spread across two physical circuits 26, 261 from the Core 6 to the provider's head-end.

Each Physical circuit 16, 26, 261 from a Provider's site has within it a single control-Plane-Peer eBGP Routing VLAN. This Peer delivers Prefix advertisements for the total of the services being delivered by all of the aggregate VLANs sharing the same physical connection from the Provider site. Inbound prefix filtering and community marking is performed at the Control Plane Router 5. The prefix filter provides a security control ensuring that a given site, (member or provider), only advertises authorised ranges.

Outbound community based filtering allows a Member 3, 4 to selectively choose either all Provider Prefixes or a sub-set of service specific Prefixes from the Provider.

Prefixes are assigned a set of communities on the Control Plane router 5 via an inbound Route-map on the BGP Peer from the Providers' Customer equipments 1, 2. Inbound prefixes from the Provider Customer equipment 1, 2 are only allowed into the Control Plane Router 5 if they come from the known Range of Prefixes expected from that Member 1, 2.

In a variant embodiment shown in FIG. 4, resilience is provided by the provision of two diverse connections to two separate switch points of presence (POPs) 6, 8. In FIG. 4, components are labelled as in FIG. 1, with the primary router and switch numbered 5, 6 as before, the duplicate router and switch labelled as 7, 8 respectively and other components in the duplicate connection numbered correspondingly. As a general principle one of the available Traffic Forwarding VLANs and associated Control-Plane VLAN between any Provider 1 and Member 3 is designated the Primary Connection 13. A second VLAN 8 and associated control plane 7 is provided as a secondary connection 131. The arrangement at both Member and Provider sites 1, 2 may be varied to allow the system to be overlaid on existing conventional implementations at any given site.

FIG. 5 shows the connectivity of the embodiment of FIG. 4 overlaid on existing access arrangements. The provider 1 is shown as having duplicate peering routers 100, 101, both of which can access local access gateways 190, 191 which give access through access gateways 90, 91 to a network 9 running under the Internet Protocol but accessible only to pre-authorised organisations (a so-called “extranet”) or only to members of a single organisation (an “intranet”). Such networks typically operate a firewall system to limit access between their users and the public internet. Similarly, the subscriber 3 has a peering router 30, which is coupled to local access gateways 390, 391 which again are connected to internet gateways 92, 93. The local access Gateways 190, 191, 390, 391 are the interfaces between the Points of presence (POP's) 6, 8 of the virtual LAN system of the invention and those of the conventional connections. Normal access is therefore available to the users of the network, and the invention can be overlaid on the existing infrastructure by the provision of main and duplicate control plane routers 5, 7, causing the local access routers to route data between the provider 1 and member 3 (and vice versa) through the primary or secondary switches 6, 8. The conventional extranet 9 draws traffic from the Member network 30 to the Primary CE 290, even in the event of a Primary link failure, to ensure that NAT persistency is maintained during failover. This implementation of the present invention takes into account both the retention of this feature and the need to preferentially route traffic over the dedicated VLAN connection 6, 8 for designated provider prefixes. In general this requires the Primary leg 6 to be aligned with the Primary conventional connection 190, 390 at each end.

Generally the selection of the dedicated connection will be performed based on longest match prefixes, since the intention is to advertise more explicit prefixes over the eBGP connections than are advertised over the conventional connection. However, to cater for instances where identical prefixes are delivered from the two sources, having the same prefix length, then the following design provides relevant design aspects.

In general the conventional connections maintain a Primary/Secondary relationship, together with NAT persistence across the two Member equipments using a combination of the route-reflection from Secondary to Primary CE, and a weight attribute in the routing information. The conventional design allows for reflection of Provider prefixes to the Primary CE from the Secondary CE, with Provider Prefixes being preferred from the Primary CE WAN interface due to a high weight (1000) being applied to these prefixes. By setting of the weight attribute to 2000 on Prefixes arriving from the Control Plane Router 5 for the dedicated link, it can be arranged that these prefixes are always preferred over any conventional Prefixes arriving over the conventional link 92. Similarly, setting of Weight 1500 on Prefixes arriving over the Secondary connection 7, 8 ensures that again such Prefixes are preferred to prefixes arriving over the conventional Primary Link 92, 93 but not over the dedicated primary link 5, 6. If both Primary & Secondary dedicated Links fail then the CE's will revert back to routing via the conventional Primary/Secondary feeds 390, 391 as in normal operation, provided that the same prefixes or associated aggregate prefixes have been advertised over the conventional connections. The conventional connection, being a switched network having several possible routings, will be more robust than the virtual fixed link, but because the connections are not dedicated to the point to point link the transmission will be more subject to delays through longer routings and contention for capacity than on the dedicated connection.

The resulting Traffic flow over the system of FIG. 5 between Member 3 and Provider 1 in normal operation is shown in FIG. 6, whilst in the event of a failure of the Primary Link 6 the resulting traffic flow is shown in FIG. 7.

Where no iBGP Link exists at a Provider head-end and BGP Routing is delivered into the Provider, then notification to the Provider that the Primary Connection has failed is reliant on delivery of explict prefixes for the affected Members into the Provider. Where this is not possible, an iBGP link may be provided between the Provider Head-end CE's or, alternatively, delivery of accesses from both Core POPs to each of the head-end CE's.

Typical conventional implementations of the BGP Minimum Route Advertisement Interval Timer is on a per BGP Peer basis, and not by destination Prefix & Peer. The net effect of this is that, left to default settings, competing Prefix advertisements within both the Control Plane Routers and within the edge CE's can hold back route withdrawals for up to 30 seconds. In order to align with the iBGP default timer, the eBGP Peers should have their Timer reduced to 5 seconds. In the absence of competing prefix withdrawals, this will allow failover on a dedicated virtual LAN connection to meet a convergence target of about 10 seconds.

It is important that burst profiles are dimensioned such that they do not incur queuing penalties within the L2 domain. This is necessary for designing a QOS policer that never drops, and also for understanding any temporal queuing points in the layer 2 switch.

FIG. 8 illustrates a network incorporating both this invention and that of the co-pending application discussed above. Separation between the various subscriber terminals 3, 4. . . . n is arranged in the multiplex mode (dotted lines) by means of the one-way provision of this invention, whilst in the unicast mode of the other invention (solid line) separation is provided by the individual virtual links. This separation ensures that no terminal can “spoof” another—that is to misrepresent its own transmissions as those of another terminal.

1. A communications system having means for operating a virtual private connection over a switched network between at least two specified terminations, the system comprising means for identifying data to be transmitted between the specified terminations, means for generating data header information for such data, and one or more switches arranged to recognise said data header information and transmit data having such information over predetermined connections in the network.

2. A communications system according to claim 1, wherein each termination point has a plurality of such virtual private connections all connected across a single physical connection.

3. A communications system according to claim 2, wherein the switch has means for comparing data origin information in the header with the physical origin of the data, and only forwarding such data if the data origin header information and physical origin correspond.

4. A communications system according to claim 1, further comprising a router controlling the switch or switches, the router having means for recognising the data header information and generating instructions to the switches to set up the routings to be used by the switches to transmit data carrying the same data header information

5. A communications system according to claim 1, in which data carrying said data header information is prioritised over other data for the same destination terminations, such that data latency is minimised.

6. A communications system according to claim 5, wherein the predetermined connections have a weighting applied such that data to be carried over such connections take precedence over data to be carried over other connections.

7. A communications system according to claim 1 comprising means for establishing a predetermined primary connection and at least one predetermined secondary connection, the switch being arranged such that data is routed by the secondary connection in the event of failure of the primary connection.

8. A communications system according to claim 1, comprising means for transmitting the same data over a plurality of separate virtual circuits to, or from, one or more of the terminations, the separate circuits carrying the data from, or to, different terminations.

9. A communications system according to claim 1 arranged for multicast operation, wherein the connection to one of the terminations is arranged only to transmit data, and the connections to the other terminations are arranged only to receive data

10. A method of establishing a communications link between at least two specified terminations over a switched network, to operate as a virtual private connection, wherein data to be transmitted between the specified terminations is identified, data header information is generated for such data, and the switches in the network are controlled to recognise such header information and route data having such header information over predetermined connections in the network.

11. A method according to claim 10, wherein the data origin information in the header is compared with the physical origin of the data, and such data is only forwarded if the data origin header information and physical origin correspond.

12. A method according to claim 9, wherein each termination point uses a single physical termination point for virtual connections to a plurality of other termination points.

13. A method according to claim 9, wherein the switches in the network are controlled by a router, the router initially recognising the data header information and generating instructions to the switches to set up the routings to be used by the switches to transmit data carrying the same data header information

14. A method according to claim 9, in which data carrying said data header information is prioritised over other data for the same destination terminations, such that data latency is minimised.

15. A method according to claim 14, wherein the predetermined connections have a weighting applied such that data to be carried over such connections take precedence over data to be carried over other connections.

16. A method according to claim 10, wherein the routing of said data is controlled to be routed over a primary connection and at least one secondary connection, the secondary connection delivering the data in the event of failure of the primary connection.

17. A method according to claim 10, wherein the same data is transmitted over a plurality of physical circuits to, or from, one or more of the terminations, the separate circuits carrying the data from, or to, different terminations.

18. A method according to claim 10, wherein the connection to one of the terminations is arranged only to transmit data, and is arranged for multicast transmission to a plurality of other terminations arranged only to receive data
